(19) United States
(12) Patent Application Publication
(10) Pub. No.: US 2016/0216844 A1
(43) Pub. Date: Jul. 28, 2016

(54) Arrangement For a Touch Sensitive Apparatus

(71) Applicant: Flatfrog Laboratories AB, Lund (SE)

(72) Inventor: Håkan Bergström, Torna-Hallestad (SE)

(21) Appl. No.: 15/007,976

(22) Filed: Jan. 27, 2016

(30) Foreign Application Priority Data
Jan. 28, 2015 (SE) 1550087-9

(51) Int. Cl. G06F 3/042; F21V 8/00

(52) U.S. Cl. CPC G06F 3/0421; G02B 6/0015; G02B 6/0065; G06F 2203/04109; G06F 2203/04103; G06F 2203/04107

(57) ABSTRACT

An arrangement for a touch sensitive apparatus comprises a light transmissive panel having a front surface and an opposite rear surface defining an optical media for transmitting light signals via total internal reflection. A shield layer is arranged at the rear surface of the light transmissive panel and is substantially non-transparent to visible light from the front surface. A refractive layer is arranged between the light transmissive panel and the shield layer and allows a light signal to propagate by total internal reflection within the light transmissive panel. At least one aperture is arranged through the shield layer and the refractive layer and is configured to allow a light signal to pass through the aperture.

The shield layer, the refractive layer, and the aperture are arranged at the periphery of the light transmissive panel.

### RELATED APPLICATION DATA

This application claims the benefit of priority of Swedish Patent Application No. 1550087-9 filed on Jan. 28, 2015, and titled “An Arrangement For a Touch Sensitive Apparatus”, which is incorporated by reference herein in its entirety.

### FIELD OF THE INVENTION

The present invention relates to an arrangement for a touch sensitive apparatus which provides for shielding components arranged at a rear surface of a light transmissive panel of the touch sensitive apparatus. The invention also relates to a film including layers of the arrangement to be applied to the light transmissive panel, a method for arranging the layers, and a touch sensitive apparatus including the arrangement.

### BACKGROUND OF THE INVENTION

Touch-sensing systems (“touch systems”) are in widespread use in a variety of applications. Typically, the touch systems are actuated by a touching object such as a finger or stylus, either in direct contact, or through proximity (i.e. without contact), with a touch surface. Touch systems are for example used as touch pads of laptop computers, in control panels, and as overlays to displays on, e.g., hand held devices, such as mobile telephones, but also on larger devices and displays. A touch panel that is overlaid on or integrated in a display is also denoted a “touch screen”. Many other applications are known in the art.

There are numerous known techniques for providing touch sensitivity, e.g. by incorporating resistive wire grids, capacitive sensors, strain gauges, etc. into a touch panel. There are also various types of optical touch systems, which e.g. detect shadows cast by touching objects onto a touch surface, or detect light scattered off the point(s) of touching objects on a touch panel.

One specific type of optical touch system uses projection measurements of light that propagates on a plurality of propagation paths inside a light transmissive panel that defines a touch surface. The projection measurements thus quantify a property, e.g. power, of the light on the individual propagation paths, when the light has passed the panel. The light propagates inside the panel by total internal reflection (TIR) against the touch surface, such that objects on the touch surface causes the propagating light on one or more propagation paths to be attenuated, commonly denoted FTIR (Frustrated Total Internal Reflection). For touch determination, the projection measurements may be processed by simple triangulation, or by more advanced image reconstruction techniques that generate a two-dimensional distribution of disturbances on the touch surface, i.e. an “image” of everything on the touch surface that affects the measured property.

Electric components of the system for touch sensing may be mounted on the rear surface of the light transmissive panel at the periphery thereof. A light transmissive panel is known having a shield arranged intermediate the rear surface and the electric components. The shield serves the purpose of hiding diffuser and the internal structure of the apparatus, including electric components from view. Therefore, the shield is non-transmissive (opaque) to visible light while being transmissive to the light (in the IR-field or near-IR-field) emitted by emitters and detected by detectors and forms an IR-transmissive filter.

However, the emitted light interacts with the IR transmissive layer multiple times as it propagates via TIR through the glass, which can cause small amounts of IR absorption of light that dramatically can attenuate the signal as it travels. This is even worse in the case where an additional reflective coating or film is applied since the losses in these materials may be substantial. Silver is one of the preferred materials due to its relatively low absorption loss in the NIR region however it tends to be too expensive for high volume consumer products.

### SUMMARY OF THE INVENTION

Embodiments of the present invention address recognized needs to allow components to be arranged on the light transmissive panel along a path of a light beam propagating via TIR without causing FTIR of the light beam and/or causing attenuation of the light beam at the position of the component.

Accordingly, embodiments of the present invention preferably seek to mitigate, alleviate or eliminate one or more deficiencies, disadvantages or issues in the art, such as the above-identified, singly or in any combination by providing an arrangement for a light transmissive panel onto which components of a touch sensing system may be arranged.

The invention is defined by the appended claims.

An arrangement for a touch sensitive apparatus comprises a light transmissive panel having a front surface and an opposite rear surface defining an optical media for transmitting light signals via total internal reflection. A shield layer is arranged at the rear surface of the light transmissive panel. A refractive layer is arranged between the light transmissive panel and the shield layer. The refractive layer allows a light signal to propagate by total internal reflection within the light transmissive panel. At least one aperture is arranged through the shield layer and the refractive layer and is configured such that a light signal may pass through the aperture. The shield layer, the refractive layer, and the aperture are arranged at the periphery of the light transmissive panel.

The arrangement may comprise at least one component arranged at or on the shield layer. The component may be printed on the shield layer. The aperture may be arranged closer to the periphery of the light transmissive panel than the component.

The at least one aperture may be arranged at the edge of the light transmissive panel.

The light transmissive panel may have a first refractive index and the refractive layer may have a second refractive index, which is lower than the first refractive index. The second refractive index may be in the range of 1.15 to 1.45, preferably in the range of 1.20 to 1.40.

The refractive layer may comprise or be made of a fluoropolymer, such as an amorphous fluoropolymer. The refractive layer may have a layer thickness larger than 3 μm.

The aperture may comprise an IR transparent substance, such as an IR transparent ink, for example a near-infrared transparent substance.

The shield layer may comprise a substantially opaque light absorbing substance, optionally substantially having the same colour as a colour of the aperture.

A film for a light transmissive panel of a touch sensing apparatus comprises a refractive layer having a front surface and an opposing rear surface having a first refractive index; a shield layer arranged at the rear surface of the refractive layer and being substantially non-transparent to visible light from the front surface of the refractive layer; and at least one aperture arranged through the shield layer and through the refractive layer and being configured to allow a light signal to pass through the aperture.

The film may comprise at least one electric component printed on the shield layer.

A method for mounting a shield layer for shielding components of a touch sensing system, comprises providing a light transmissive panel having a front surface and an opposite rear surface defining an optical media for transmitting light signals via total internal reflection; arranging a refractive layer on the rear surface of the light transmissive panel, which allows a light signal to propagate by total internal reflection within the light transmissive panel; and arranging a shield layer on the rear surface of the refractive layer, which is substantially non-transparent to visible light from the front surface; and providing at least one aperture through the shield layer and the refractive layer, which is configured to allow a light signal to pass through the aperture. The shield layer, the refractive layer, and the aperture are arranged at the periphery of the light transmissive panel.

The method may comprise arranging a component on the shield layer, such as printing the component on the shield layer. The component may be an electrical component.

A touch sensitive apparatus for a touch sensing system comprises a light transmissive panel and is configured to operate using light signals. The touch sensitive apparatus comprises the arrangement and components arranged at or on a rear surface of the light transmissive panel and at a shield layer of the arrangement to be invisible from the front surface of the light transmissive panel.

Some embodiments of the invention provide for a light signal to enter the light transmissive panel through the aperture. The light signal then propagates through the light transmissive panel, unaffected by the components arranged at the rear surface of the light transmissive panel due to the refractive layer positioned between the light transmissive panel and the component arranged at or on the rear surface of the shield layer with maintained TIR properties such as if no layer was applied to the light transmissive panel. Also, the shield layer as well as the aperture makes the components substantially invisible to the human eye when looking down at the light transmissive panel.

The term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which embodiments of the invention are capable of, will be apparent and elucidated from the following description of embodiments of the present invention, reference being made to the accompanying drawings, in which

FIG. 1 is a cross-sectional view of an example of the arrangement for the touch sensitive apparatus;

FIG. 2 is a cross sectional view of another example of the arrangement for the touch sensitive apparatus;

FIG. 3 is a schematic illustration of a touch sensing system comprising the arrangement for the touch sensing apparatus; and

FIG. 4 is a flow-chart of a method for mounting the shield layer and the refractive layer.

FIG. 5 provides a graph showing example leakage of the light signal through the refractive layer.

### DESCRIPTION OF EMBODIMENTS

Specific embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

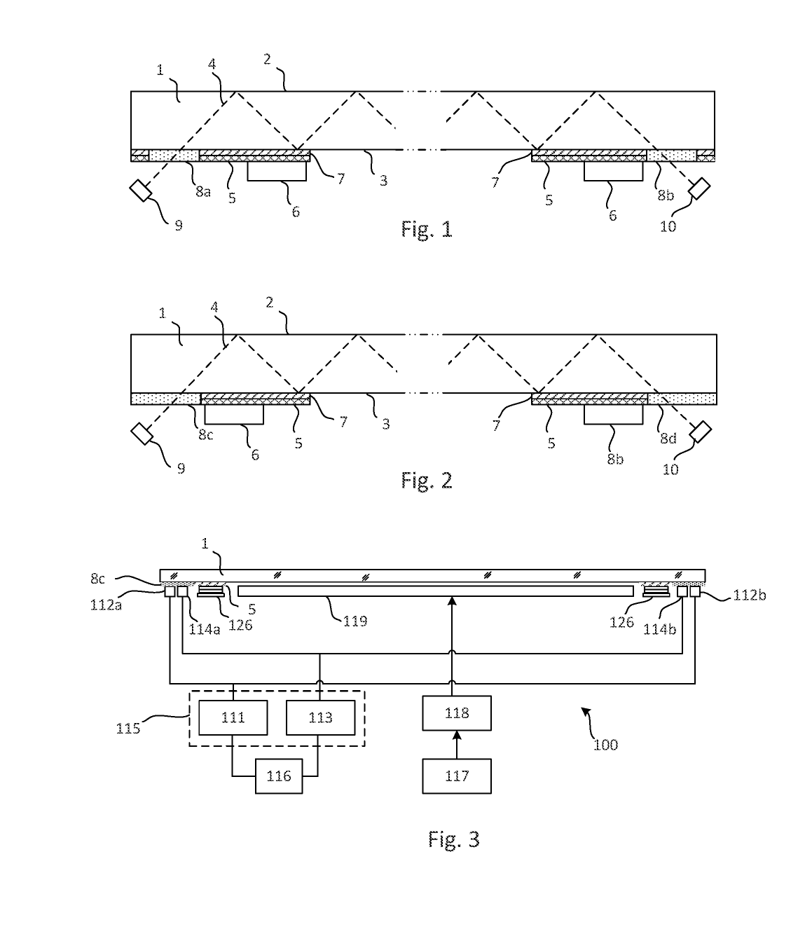

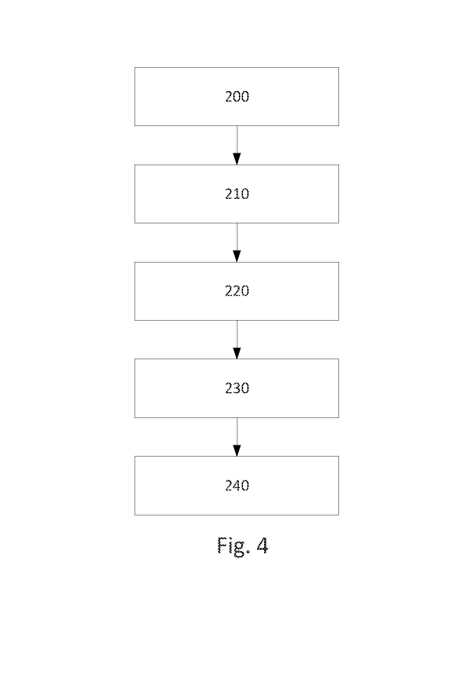

FIG. 1 illustrates an embodiment of an arrangement for a touch sensitive apparatus. The arrangement comprises a light transmissive panel 1 having a front surface 2 and an opposite rear surface 3. The light transmissive panel 1 will be referred to as a panel in the following.

The front surface 2 and the rear surface 3 define an optical media for transmitting light signals 4, also referred to as optical signals, such as via total internal reflection (TIR). The light signals may be light signals in the IR, such as near-infrared, spectrum. In FIG. 1, the left and right portions of the panel 1 are illustrated but not the complete middle section of the panel 1.

A shield layer 5 is arranged at the rear surface 3 of the panel 1. The shield layer 5 may be substantially non-transparent or opaque to visible light from the front surface 2. Hence, components 6, such as electric components, arranged at a rear surface of the shield layer 5 are invisible from the front surface 2 of the panel 1. A refractive layer 7 is arranged between the panel 1 and the shield layer 5. The refractive layer 7 allows the light signal 4 to propagate by TIR within the panel 1, such as substantially without attenuation of the light signal 4 by the shield layer 5 while the components 6 are shielded and at the same time do not cause frustrated total internal reflection (FTIR) of the light.

At least one aperture 8a, 8b is arranged through both the shield layer 5 and the refractive layer 7 and is configured to allow the light signal 4 to pass through the aperture 8a, 8b. For example, the light signal 4 may be generated by an emitter 9, enter into the panel 1 through a first aperture 8a, propagate by TIR through the panel 1, and exit the panel 1 through a second aperture 8b and detected by a detector 10. In some embodiments, the emitter and detector are arranged in pairs at an aperture, such that light may enter into and exit from the panel 1 via the same aperture 8a, 8b.

The refractive layer 7 may have a refractive index that is a low refractive index. The panel 1 has another refractive index, which is higher than the refractive index of the refractive layer 7. Consequently, the panel 1 may have a first refractive index and the refractive layer 7 may have a second refractive index, which is lower than the first refractive index. This allows for the light signal 4 to propagate through the panel 1 via TIR substantially without attenuation even at the area of the shield layer 5. The refractive index of the refractive layer may be in the range of 1.15 to 1.45, preferably in the range of 1.20 to 1.40. In some embodiments, the refractive index of the refractive layer 7 is in the range of 1.23 to approximately 1.33, which is useful for FTIR solutions with high theta (angle of TIR at the surface of the panel) designed to suppress interaction with water on the front surface 2 of the panel 1. Such ranges are applicable to touch systems designed to cause FTIR by touch interaction with the panel, such as in a panel made of soda lime glass. In some embodiments, the panel 1 is a glass panel. In a preferred embodiment, a material having a high refractive index is used, such as Sodalime, which has a refractive index of 1.51. A larger difference between the refractive index of the panel material and the refractive layer 7 is desirable in order to allow total internal reflection of light in the panel at an optimal range of angles. Materials such as PMMA (Poly(methyl methacrylate)) with a refractive index of 1.46 may also be used in order to minimize production costs.

In some embodiments, the refractive layer 7 comprises a fluoropolymer. The fluoropolymer may be an amorphous fluoropolymer, such as CYTOP® available from AGC Chemicals Europe Ltd. Such a fluoropolymer layer provides for transparency, low refractive index, low optical absorption and good lamination properties. In other embodiments, the refractive layer comprises Teflon. Still other alternatives are nanostructured materials providing an air filled structure, such as a structure by Silicon void particles provided by Dai Nippon Printing Co., Ltd. Hence, the refractive layer 7 will substantially not affect the visible properties of the panel 1, which is of importance in the center of the panel where a display device 119 (FIG. 3) may be arranged.

The refractive layer 7 may be provided as a coating and/or as a film. Hence, the refractive 7 may be coated to the panel 1, such as by screen printing, or applied as a film. Alternatively, the refractive layer may be applied by means of a dip coating method or via a spray coating technique.

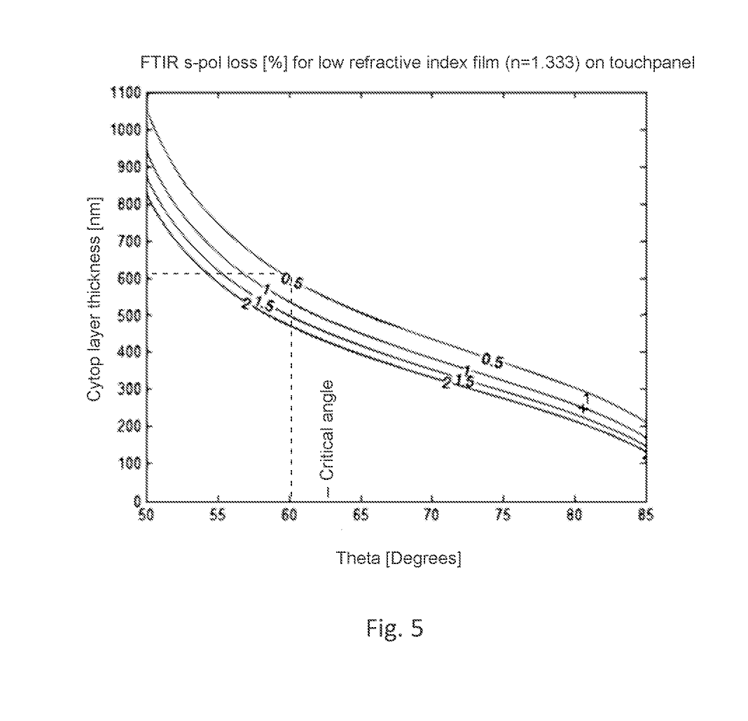

The refractive layer 7 may have a layer thickness larger than about 0.5 μm, such as larger than 1 μm. In some embodiments, it is larger than 3 μm. The actual thickness depends both on the actual refractive index of the panel, the actual refractive index of the refractive layer 7, and the object eventually frustrating the light at the front surface 2. Furthermore, the thickness is dependent on how close to the critical angle between the panel 2 and refractive layer 7, and the maximum leakage of the light signal that is accepted. FIG. 5 provides a graph showing example leakage of the light signal for each total internal reflection of the light signal by the refractive layer 7. The graph shows the leakage relative to the thickness of a refractive layer 7 formed from CYTOP® for a specific touching object and the angle theta of the light beam. For example, where a % loss of 0.5 is acceptable for a theta range of between 60° and 80°, it can be seen from the graph that a minimum thickness of refractive layer 7 would be 620 nm (0.62 μm).

Another advantage of the refractive layer 7 is that it reduces the amount of ambient light reflection perceived by the user when looking at the display mounted transmissive panel. The total of the reflections between the air and the transmissive panel and the transmissive panel and the refractive layer is less than that of the air-panel interface without the refractive layer.

The aperture 8a, 8b may comprise an IR transparent substance, such as an IR transparent ink or dye, and as such form a filter aperture. In some embodiments, the IR transparent substance is transmissive in the near-infrared spectrum, which may comprise the spectrum within which the touch sensing system is operative. Hence, the arrangement according to embodiments of the invention provides for allowing the infrared light to be emitted into the glass panel whilst shielding components arranged at the aperture 8a, 8b also from the front surface 2. Furthermore, the requirements on the IR transparent substance of the aperture 8a, 8b are less demanding than in previous systems not having a refractive layer and using an IR transparent ink as the substance for shielding components, as the light only passes through it twice (once to enter, once to exit). Furthermore, since it only passes twice, embodiments of the invention provides for little attenuation of the light signal 4 compared to systems employing an IR transmissive layer as the shield. The light signal is allowed to enter or exit the aperture 8a, 8b using an incoupling/outcoupling structure for coupling the light into/out of the panel 1, as is generally known in the art and will not be further described herein. Such coupling structures are, e.g., described in US2014253831 by the same applicant as the present invention, which is incorporated herein by reference for all purposes. Preferably, the aperture comprises a material with a refractive index greater than or equal to both the material from which the transmissive panel is formed and the material (e.g. resin) from which the emitters and detectors are formed.

In some embodiments, the shield layer 5 comprises a substantially opaque substance. Hence, the shield layer 5 may form a layer that hides components arranged at the rear surface 3 of the panel 1. Additionally or alternatively, the shield layer 5 has the same colour as a colour of the aperture 8a, 8b, for example black. This provides for a finish of the shield 5 and the aperture 8a, 8b that is continuous to the human eye whilst allowing optimized transmissive properties of the light signal 4 in the panel 1.

The shield layer 5, the refractive layer 7, and the aperture 8a, 8b are arranged at the periphery of the panel 1. In one embodiment, the shield layer 5 and the refractive layer 7 may form a border at the edge of the panel 1, which shields components spaced around the circumference of the panel 1. A plurality of apertures 8a, 8c, may be arranged at the periphery of the panel 1, such as at the periphery of the shield layer 5 and the refractive layer 7, and are set back from the edge of the panel by the thickness of the border as is illustrated in FIG. 1. The plurality of apertures 8a, 8b may be spaced at each side of the rear surface 3 of the panel 1, such as equidistantly spaced along each side. Hence the arrangement of embodiments of the invention allow for arranging the apertures 8a, 8b for a touch sensing system such as described in U.S. Pat. No. 3,673,327, U.S. Pat. No. 4,254,333, U.S. Pat. No. 6,972,753, U.S. Pat. No. 7,432,893, US2006/0114237, US2007/0075648, WO2009/048365, US2009/0153519, WO2010/006882, WO2010/064983, WO2010/134865 and WO2012/105893, which are incorporated herein by reference for all purposes.

The aperture may extend axially though the shield layer 5 and the refractive layer 7. The size of the aperture may be in the range of smaller than or equal to 1.5 mm² for touch screens with a diagonal length of up to 42″, and as large as 7.5 mm² for touch screens with a diagonal length of 65″. In one embodiment, the aperture for an emitter may be smaller than the aperture for a detector.

For a touch sensing system according to the above examples, the number of apertures spaced around the circumference of the panel 1 depends on the desired touch separation resolution. Embodiments may comprise 119 apertures for touch screens with a diagonal length of 23″ with high touch separation resolution. Where moderate touch separation resolution is required, 96 apertures for touch screens with a diagonal length of 46″, and 140 apertures for touch screens with a diagonal length of 65″ is preferred. FIG. 2 illustrates an embodiment wherein the aperture 8c, 8d is arranged at the edge of the panel 1. An edge of the aperture 8c, 8d is arranged substantially at an edge of the panel 1. The aperture 8c, 8d extends from the edge of the panel towards the centre of the rear surface 3 of the panel 1. Hence, this allows for arranging the emitter 9 and/or detector 10 closer to the edge of the panel compared to the embodiment of FIG. 1, wherein a larger effective area of the panel 1 for the same width of the shield layer 5 and the refractive layer 7 is maintained. Alternatively, this allows for a larger effective area of the shield layer 5 at which components 6 may be arranged.

In other embodiments, one or several apertures 8a, 8b may be arranged according to the embodiment of FIG. 1, whereas other apertures 8c, 8d may be arranged according to the embodiment of FIG. 2. Still other combinations and arrangements are conceivable where the aperture 8a-8d is arranged at different horizontal positions through the shield layer 5 and the refractive layer 7.

The arrangement may comprise the least one component 6 arranged at the shield layer 5 and at the rear surface 3 of the panel 1, such as on the shield layer 5. In some embodiment, the component 6 is an electric component, such as a printed electronic circuit using any of screen printing, flexography, gravure, offset lithography, and/or inkjet printing technique. The component 6 may be printed on the shield layer 7. Electrically functional electronic or optical inks may be deposited on the shield layer, creating active or passive devices, such as thin film transistors or resistors. This may include the connection grid itself, e.g., the PCB traces. In one embodiment, the connection grid may be placed onto the shield layer after the components have been placed, thereby electrically connecting the mounted components. Printing of electric components is generally known and will not be described in more detail herein. However, by providing the refractive layer 7 between the shield layer 5 and the panel 1, the light signal 4 will not be frustrated at the position of the component 6, such as is illustrated to the left in FIG. 1. Hence, the properties of the light signal 4 when reflected by TIR at the position of the component 6 are maintained also at the periphery of the panel 1 where the components 6 are arranged. Using a printing technique allows for arranging the components on the surface of the shield layer 5 also when the panel is curved.

In some embodiments, the aperture 8a-8d is arranged closer to the periphery of the panel 1 than the component 6, which provides for a large effective area of the panel 1 suitable for touch sensing applications.

In some embodiments, the refractive layer 7 and the shield layer 5 are provided as a sheet or film to be applied to the rear surface 3 of the panel 1 as a unit. Such a film comprises a refractive layer 7 having a front surface and an opposing rear surface. It also has a first refractive index. The shield layer 5 is arranged at the rear surface of refractive layer 7 and is substantially non-transparent to visible light from the front surface of the refractive layer. At least one aperture 8a-8d is arranged, such as vertically, through the shield layer 5 and the refractive layer 7 and is configured to allow the light signal 7 to pass through the aperture 8a-8d, such as has been described above. Providing the refractive layer 7 and the shield layer 5, as well as the aperture 8a-8d as a film or sheet allows for mounting them in a single step. In some embodiments, the film comprises at least one component 6 printed on the shield layer 5, such as described above. The component 6 may be printed before or after mounting the film on the panel 1. Mounting before provides for mounting both the film and the component 6 in a single step.

Hence, in various embodiments the shield layer 5 may be formed as a screen-printed coating made of a plastic material, which is dyed with an opaque dye. Such a screen-printed coating may be applied in cost effective manner with well-controlled thickness and location on the light transmissive panel. In a variant, the shield layer 5 is formed as a spray-on painted coating made of a plastic material. In a further variant, the shield layer 5 is formed as a pre-produced plastic film with an opaque dye. The pre-produced film may be disposed on, e.g. be laminated or glued to, the refractive layer 7.

FIG. 3 illustrates an embodiment of a touch sensing system 100 including the arrangement according to embodiments of the invention. In FIG. 3, the system 100 includes an activation controller 111 which is connected to selectively control or modulate the activation of the light emitters 112a, 112b and, possibly, a touch controller 113 to selectively detect or provide readout of data from the light detectors 114a, 114b. The activation controller 111 and touch controller 113 may also be implemented as a single controller 115 for controlling the touch sensing system. Depending on implementation, the light emitters 112a, 112b and/or detectors 114a, 114b may be activated in sequence or concurrently, e.g. as disclosed in WO2010/064983. One or both of the touch controller 111 and the activation controller 113 may be at least partially implemented by software stored in a memory unit 116 and executed by a processing unit. A main controller 117 may be connected to a display controller 118 which is configured to generate a user interface on a display device 119 based on control signals from the main controller 117. The main controller 117 is thereby operable to coordinate the user interface on the display device 119 with the data from the touch detection system, e.g. touch data from the touch controller 113.

One or several components 126, such as any of the components 111, 113 and 115-118 mentioned above and/or connections there-between, may be arranged at the shield layer 5. In some embodiments, the components 126 are printed on the shield layer, such as described above. In other embodiments, the components 126 are attached to the shield layer 5 using an adhesive material. In such an embodiment, an index matched adhesive is used to mount the emitter and detector components by direct glue application in a pick & place process or by adding the adhesive afterwards e.g. by under filling. Electrical connection of emitters and detectors may then be made via flex, bond threads or direct print.

In the embodiment of FIG. 3, any of the components 111, 113 and 115-118 may be printed or arranged on the shield layer 5.

The components 6, 126 may be printed to film using printing techniques for printing components as has been described above. Then, the film with the electric components 120 may be mounted on the panel 1. Alternatively, the film is first mounted on the panel 1 and subsequently the components 6, 126 are applied to the film previously mounted on the panel 1. Hence, the invention provides for a flexible and inexpensive mounting process.

Previously, an adhesive with an appropriately refractive index would need to be selected to fix any components to the panel within the active display area, otherwise FTIR would be disrupted and noise introduced to the system by the adhesive. A significant advantage of having the refractive/shield layer on the light transmissive panel is that components may be mounted via direct bond within the active display area with no refractive requirements on the bond, allowing cheaper materials to be used. This also enables mechanical mount surfaces to be positioned more liberally for the same reasons.

According to a method for mounting a shield layer 5 for shielding components of a touch sensing system, in a step 200 the panel 1 having the front surface 2 and the opposite rear surface 3 defining an optical media for transmitting light signals via total internal reflection is provided. In a step 201, the refractive layer 7 is arranged on the rear surface 3 of the panel 1. The refractive layer 7 allows the light signal 4 to propagate by TIR within the panel 1. The refractive layer 7 may have the properties as discussed above. The refractive layer 7 may be applied as a coating, such as by screen printing or otherwise applying the layer, with properties and dimensions as discussed above. The refractive layer 7 may also be applied as a film, optionally together with the shield layer 5.

In a step 220, the shield layer 5 is applied to the refractive layer 7. The shield layer 5 may be applied to the refractive layer 7 as a coating. Alternatively or additionally, the shield layer 5 may be applied using screen printing. It is also possible to apply the shield layer 5 as a film, optionally together with the refractive layer 7. The shield layer 5 may have the properties and dimensions as discussed above. Hence, the shield layer 5 may be applied to the refractive layer 7 before both are mounted to the panel 1 simultaneously. Alternatively, the refractive layer 7 is first mounted to the panel 1, and then the shield layer 5 is applied to the refractive layer 7.

In step 230, the aperture 8a-8d is applied in the refractive layer and the shield. The aperture may be applied by providing a gap or through-hole in the refractive layer 7 and the shield layer 5 during previous steps. Then, the material of the aperture 8a-8d is applied in the gap or through-hole. The aperture 8a-8d may have the properties and dimensions as discussed above. Hence, the aperture 8a-8d may be configured to allow a light signal to propagate through the aperture 8a-8d. A material may be applied in the gap to form a filter aperture 8a-8d, which may, e.g., be applied by screen printing. The material of the filter aperture may, e.g., be applied using an overprinting technique wherein the aperture is applied after the other layers and at the positions left in the layers for forming the aperture 8a-8d. For example, an inverse of a pattern used for forming the refractive layer 7 and/or the shield layer 5 may be used for forming the aperture 8a-8d. Using screen printing and overprinting techniques basically allows for forming any shape of the aperture and the layers. Applying the material of the aperture 8a-8d after the refractive layer 7 and the shield layer 5 allows for a slight overlap between the material of the aperture 8a-8d and the layers 5, 7. This provides for a complete shield of components 6, 126 when viewed from the front surface 2. Providing the aperture 8a-8d as a relatively small area within the refractive layer 7 and the shield layer 5 provides for a relatively inextensible arrangement at the same time as the finish may be high. By providing an aperture having IR transmissive properties only where the light signal enters/exits the panel 1, a material that is non-transparent to IR light may be used at areas where the light signal should not enter/exit the panel. This provides for a less expensive arrangement, as IR-transparent materials are normally more expensive than opaque materials. However, the two materials may still have the same or substantially the same visible appearance. Furthermore, an IR-transparent material is not 100% blocking visible light incident from the front surface 2 of the panel 1. Therefore, the cosmetic finish is poorer than for an opaque material and a color shift, e.g. a bluish tint, can be seen. Hence, it is less suitable for larger areas, but applicable to smaller unnoticeable areas such as the apertures 8a-8d without deteriorating the finish of the panel.

In some embodiments, the refractive layer 7 and the shield layer 5 are arranged as a frame that may be provided at the panel 1. When mounted, the layers 5, 7 are arranged at the periphery of the panel 1. At the center of the panel at the rear surface 3 of the panel, the display 119 may be arranged. Hence, the layers 5, 7 will not shield or affect the visibility of the display 119. Furthermore, the aperture 8a-8d may be arranged at the periphery of the refractive layer 7 and the shield layer 5. The refractive layer 7 and the shield layer 5 may be arranged between the aperture 8a-8d and the edge of the panel 1, such as illustrated in FIG. 1. Hence, the aperture 8a-8d may be horizontally surrounded by the refractive layer 7 and the shield layer 5 and may vertically extend through the layers 5, 7. This may, e.g., allow for providing the layers as a film, wherein the film has a continuous edge, wherein an easier mounting process of the film may be achieved. In other embodiments, the aperture 8a-8d extends all the way to the edge of the film, such as illustrated in FIG. 2. Arranging the aperture 8a-8d as close as possible to the edge provides for a panel having a large area for touch sensing. The closer to the edge the emitter 112a, 112b is arranged; the larger the active area of the panel 1 will be for a fixed size of the panel 1.

In a step 240, the components 6, 126 are applied to or disposed on the shield layer 5, such as printed to the shield layer 5. In some embodiments, the components 6, 126 are applied prior to the refractive layer 7 and the shield layer 5 are mounted to the panel 1. In other embodiments, the components 6, 126 are applied to the shield layer after the refractive layer 7 and the shield layer 7 are mounted to the panel 1. Hence, the invention provides for a flexible manufacturing process, wherein the mounting process of the electric components 6, 126 may be optimized.

It should also be appreciated that features disclosed in the foregoing description, and/or in the foregoing drawings and/or following claims both separately and in any combination thereof, be material for realizing the present invention in diverse forms thereof. When used in the following claims, the terms “comprise”, “include”, “have” and their conjugates mean, “including but not limited to”.

The present invention has been described above with reference to specific embodiments. However, other embodiments than the above described are equally possible within the scope of the invention. Different method steps than those described above may be provided within the scope of the invention. The different features and steps of the invention may be combined in other combinations than those described. The scope of the invention is only limited by the appended patent claims.

1. An arrangement for a touch sensitive apparatus, comprising
a light transmissive panel having a front surface and an opposite rear surface defining an optical media for transmitting light signals via total internal reflection;
a shield layer arranged at the rear surface of the light transmissive panel and being substantially non-transparent to visible light from the front surface;
a refractive layer arranged between the light transmissive panel and the shield layer and that allows an light signal to propagate by total internal reflection within the light transmissive panel; and
at least one aperture arranged through the shield layer and the refractive layer and being configured to allow a light signal to pass through the aperture;
wherein the shield layer, the refractive layer, and the aperture are arranged at the periphery of the light transmissive panel.

2. The arrangement of claim 1, wherein the arrangement comprises at least one electric component arranged at the shield layer, such as printed on the shield layer.

3. The arrangement of claim 2, wherein the aperture is arranged closer to the periphery of the light transmissive panel than the printed electric component.

4. The arrangement of claim 1, wherein the at least one aperture is arranged at the edge of the light transmissive panel.

5. The arrangement of claim 1, wherein the light transmissive panel has a first refractive index and the refractive layer has a second refractive index, which is lower than the first refractive index.

6. The arrangement of claim 5, wherein the second refractive index is in the range of 1.15 to 1.45, preferably in the range of 1.20 to 1.40.

7. The arrangement of claim 1, wherein the refractive layer comprises an amorphous fluoropolymer.

8. The arrangement of claim 1, wherein the refractive layer has a layer thickness larger than 3 μm.

9. The arrangement of claim 1, wherein the aperture comprises an IR transparent substance, such as an IR transparent ink.

10. The arrangement of claim 1, wherein the shield layer comprises a substantially opaque light absorbing substance, optionally substantially having the same color as a color of the aperture.

11. A film for a touch panel of a touch sensing apparatus, comprising:
a refractive layer having a front surface and an opposing rear surface having a first refractive index;
a shield layer arranged at the rear surface of refractive layer and being substantially non-transparent to visible light from the front surface of the refractive layer; and
at least one aperture arranged through the shield layer and the refractive layer and being configured to allow light to pass through the aperture.

12. The film of claim 11, comprising at least one electric component printed on the shield layer.

13. A method for mounting a shield layer for shielding electric components of a touch sensing system, comprising
providing a light transmissive panel having a front surface and an opposite rear surface defining an optical media for transmitting light signals via total internal reflection;
arranging a refractive layer on the rear surface of the light transmissive panel, which allows a light signal to propagate by total internal reflection within the light transmissive panel; and
arranging a shield layer on the rear surface of the refractive layer, which is substantially non-transparent to visible light from the front surface;
providing at least one aperture through the shield layer and the refractive layer, which is configured to allow light to pass through the aperture;
wherein the shield layer, the refractive layer, and the aperture are arranged at the periphery of the light transmissive panel.

14. The method of claim 13, comprising arranging a component on the shield layer, such as printing the component on the shield layer.

15. A touch sensitive apparatus for a touch sensing system operating using light signals, comprising the arrangement according to claim 1 and components arranged at a rear surface of the light transmissive panel and on the shield layer of the arrangement to be invisible from the front surface the light transmissive panel.
